(19) United States
(12) Patent Application Publication
(10) Pub. No.: US 2024/0157977 A1
(43) Pub. Date: May 16, 2024

(54) SYSTEMS AND METHODS FOR MODELING AND PREDICTING SCENE OCCUPANCY IN THE ENVIRONMENT OF A ROBOT

(71) Applicant: Toyota Research Institute, Inc., Los Altos, CA (US)

(72) Inventors: Guy Rosman, Newton, MA (US); Igor Gilitschenski, Cambridge, MA (US); Xin Huang, Cambridge, MA (US)

(73) Assignees: Toyota Research Institute, Inc., Los Altos, CA (US); Toyota Jidosha Kabushiki Kaisha, Toyota-shi (JP)

(21) Appl. No.: 17/988,017

(22) Filed: Nov. 16, 2022

(51) Int. Cl. B60W 60/00; B60W 50/06; G05B 13/02

(52) U.S. Cl. CPC B60W 60/0027; B60W 50/06; G05B 13/027; B60W 2554/4029; B60W 2554/406

(57) ABSTRACT

Systems and methods for modeling and predicting scene occupancy in an environment of a robot are disclosed herein. One embodiment processes past agent-trajectory data, map data, and sensor data using one or more encoder neural networks to produce combined encoded input data; generates a weights vector for a Gaussian Mixture Model (GMM) based on the combined encoded input data; produces a volumetric spatio-temporal representation of occupancy in an environment of a robot by generating, for a plurality of modes of the GMM in accordance with the weights vector, corresponding sample probability distributions of scene occupancy based on respective means and variances of the plurality of modes, wherein the respective means and variances sample coefficients of a set of learned basis functions; and controls the operation of the robot based, at least in part, on the volumetric spatio-temporal representation of occupancy.

### TECHNICAL FIELD

The subject matter described herein generally relates to robots and, more particularly, to systems and methods for modeling and predicting scene occupancy in the environment of a robot.

### BACKGROUND

In a variety of robotics applications, including semi-autonomous and autonomous vehicles, robots generate occupancy maps to predict where, at a future point in time, agents (people, other robots, vehicles, etc.) will be in the environment surrounding the robot. Said differently, occupancy maps predict whether a given location in the environment will be occupied by an agent at a future point in time. Such occupancy maps support a number of different tasks performed by a robot. For example, in a vehicular application, an occupancy map can support a collision-avoidance system, an Advanced Driver Assistance System (ADAS), or the planning subsystem of an autonomous vehicle.

### SUMMARY

An example of a system for modeling and predicting scene occupancy in an environment of a robot is presented herein. The system comprises a processor and a memory storing machine-readable instructions that, when executed by the processor, cause the processor to process past agent-trajectory data, map data, and sensor data using one or more encoder neural networks to produce combined encoded input data. The memory also stores machine-readable instructions that, when executed by the processor, cause the processor to generate a weights vector for a Gaussian Mixture Model (GMM) based on the combined encoded input data. The memory also stores machine-readable instructions that, when executed by the processor, cause the processor to produce a volumetric spatio-temporal representation of occupancy in the environment of the robot by generating, for a plurality of modes of the GMM in accordance with the weights vector, corresponding sample probability distributions of scene occupancy based on respective means and variances of the plurality of modes. The respective means and variances sample coefficients of a set of learned basis functions. The memory also stores machine-readable instructions that, when executed by the processor, cause the processor to control operation of the robot based, at least in part, on the volumetric spatio-temporal representation of occupancy.

Another embodiment is a non-transitory computer-readable medium for modeling and predicting scene occupancy in an environment of a robot and storing instructions that, when executed by a processor, cause the processor to process past agent-trajectory data, map data, and sensor data using one or more encoder neural networks to produce combined encoded input data. The instructions also cause the processor to generate a weights vector for a Gaussian Mixture Model (GMM) based on the combined encoded input data. The instructions also cause the processor to produce a volumetric spatio-temporal representation of occupancy in the environment of the robot by generating, for a plurality of modes of the GMM in accordance with the weights vector, corresponding sample probability distributions of scene occupancy based on respective means and variances of the plurality of modes. The respective means and variances sample coefficients of a set of learned basis functions. The instructions also cause the processor to control operation of the robot based, at least in part, on the volumetric spatio-temporal representation of occupancy.

In another embodiment, a method of modeling and predicting scene occupancy in an environment of a robot is disclosed. The method comprises processing past agent-trajectory data, map data, and sensor data using one or more encoder neural networks to produce combined encoded input data. The method also includes generating a weights vector for a Gaussian Mixture Model (GMM) based on the combined encoded input data. The method also includes producing a volumetric spatio-temporal representation of occupancy in an environment of a robot by generating, for a plurality of modes of the GMM in accordance with the weights vector, corresponding sample probability distributions of scene occupancy based on respective means and variances of the plurality of modes. The respective means and variances sample coefficients of a set of learned basis functions. The method also includes controlling operation of the robot based, at least in part, on the volumetric spatio-temporal representation of occupancy.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. It is to be noted, however, that the appended drawings illustrate only possible implementations of this disclosure and are therefore not to be considered limiting of its scope. The disclosure may admit to other implementations.

FIG. 1 illustrates one embodiment of a vehicle within which systems and methods disclosed herein may be implemented.

FIG. 2 is a block diagram of a scene-occupancy modeling and prediction system, in accordance with an illustrative embodiment of the invention.

FIG. 3 illustrates a processing flow of a scene-occupancy modeling and prediction system, in accordance with an illustrative embodiment of the invention.

FIG. 4 is a probabilistic agent-movement diagram, in accordance with an illustrative embodiment of the invention.

FIG. 5 is a flowchart of a method of modeling and predicting scene occupancy in an environment of a robot, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Conventional approaches to generating an occupancy map suffer from an important limitation: they are unimodal. For example, in a vehicular application, two vehicles, Vehicle A and Vehicle B, might be approaching a merge from two lanes into a single lane of traffic. Conventional scene-occupancy models do not account for the multiple possible outcomes: (1) Vehicle A goes first, (2) Vehicle B goes first, or (3) Vehicle A and Vehicle B arrive at the merge at the same time. Various embodiments of a scene-occupancy modeling and prediction system disclosed herein overcome the limitations of conventional scene-occupancy models by using a set of learned three-dimensional (3D) or four-dimensional (4D) basis functions that support capturing a reasonable distribution of occupancy over time in combination with a multi-modal distribution (e.g., a Gaussian Mixture Model (GMM)) to create a multi-modal sample vector. Conditioned on that multi-modal sample vector, the system can use the basis functions just mentioned to generate a complete 3D or 4D volumetric spatio-temporal representation of occupancy in the environment of a robot. This complete representation can be used to estimate, at each time step, the probability of occupancy by an agent (e.g., a person, vehicle, motorcycle, bicycle, scooter, robot other than a vehicle, animal, etc.) of each point in the 3D or 4D space. The GMM covers the multi-modal aspect, and the learned basis functions make the presentation more efficient. In some embodiments, the learned 3D or 4D basis functions are polynomial basis functions.

Since the various embodiments estimate probability of occupancy as a function of time, the approach is fundamentally Eulerian. In one embodiment, probability of occupancy by different kinds of agents is modeled separately. For example, in a vehicular embodiment, separate volumetric spatio-temporal representations can be generated for vehicles and pedestrians.

The principles and techniques described herein can be applied to a variety of different kinds of robots. In some embodiments, the robot is a vehicle. The vehicle can be, without limitation, a manually-driven vehicle with advanced safety features (e.g., a collision-warning system, a blind-spot warning detection system, etc.); a semi-autonomous vehicle equipped with features such as an Adaptive Cruise Control (ACC) system, a Lane Keeping Assist System (LKAS), an automatic collision-avoidance system, or an Advanced Driver Assistance System (ADAS); or an autonomous vehicle (e.g., a vehicle capable of driving at a level of autonomy defined by the Society of Automotive Engineers (SAE) as Level 4 or 5). In other embodiments, the robot may be an indoor or outdoor service or assistive robot. For example, in some embodiments, the robot may be an indoor robot (e.g., a companionship robot, medical-assistance robot, etc.). In other embodiments, the robot may be an outdoor service robot (e.g., a delivery robot, military robot, etc.). In still other embodiments, the robot is a controller for a smart city. Such a robot can benefit from the techniques described herein to spatio-temporally model and predict occupancy within the smart city by various kinds of agents (e.g., people, animals, vehicles, mobile robots, etc.).

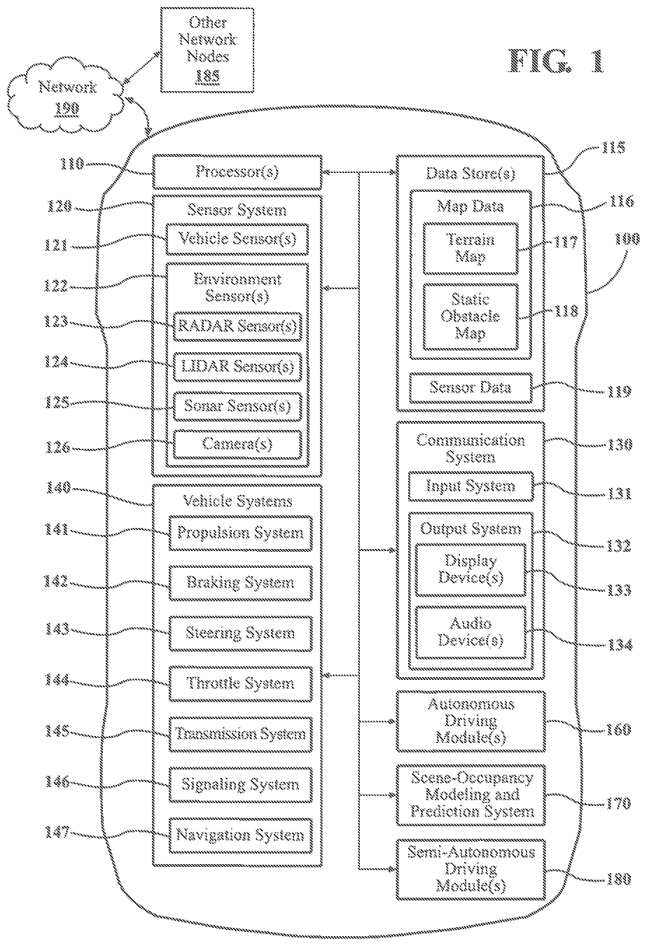

Referring to FIG. 1, an example of a vehicle 100, in which systems and methods disclosed herein can be implemented, is illustrated. As used herein, a “vehicle” is any form of motorized transport, such as, but not limited to, an automobile. In some embodiments, vehicle 100 is driven manually by a human driver but is equipped with advanced features that involve automatically analyzing the environment surrounding the vehicle, such as a collision-warning system. In other embodiments, vehicle 100 can operate in one or more semi-autonomous driving modes by virtue of an adaptive cruise control (ACC) system, a Lane Keeping Assist System (LKAS), a parking-assistance system, or an Advanced Driver-Assistance System (ADAS). These various types of semi-autonomous driving systems are shown collectively in FIG. 1 as semi-autonomous driving module(s) 180. In still other embodiments, vehicle 100 can operate, at least some of the time, in a highly autonomous driving mode (e.g., SAE Levels 3-5). In those embodiments, autonomous driving is controlled by autonomous driving module(s) 160.

As shown in FIG. 1, vehicle 100 can include a scene-occupancy modeling and prediction system 170 (hereinafter “occupancy system 170”) or capabilities to support or interact with the occupancy system 170 and thus benefits from the functionality discussed herein. Instances of vehicle 100, as used herein, are equally applicable to any device capable of incorporating the systems or methods described herein. As mentioned above, the techniques disclosed herein can be applied to other types of robots besides vehicles. For example, those techniques can be applied, without limitation, to indoor or outdoor service or assistive robots and to a controller for a smart city.

The vehicle 100 also includes various elements. It will be understood that, in various implementations, it may not be necessary for the vehicle 100 to have all the elements shown in FIG. 1. For example, in an embodiment that includes autonomous driving module(s) 160, the semi-autonomous driving module(s) 180 might not be present, and vice versa. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1, including occupancy system 170. While the various elements are shown as being located within the vehicle 100 in FIG. 1, it will be understood that one or more of these elements can be located external to the vehicle 100. Further, the elements shown may be physically separated by large distances. As shown in FIG. 1, vehicle 100 can communicate with other network nodes 185 (e.g., a server where the neural networks in occupancy system 170 are trained before the trained system is downloaded to a vehicle 100, other connected vehicles, cloud servers, edge servers, roadside units, infrastructure) via a network 190. In some embodiments, network 190 includes the Internet.

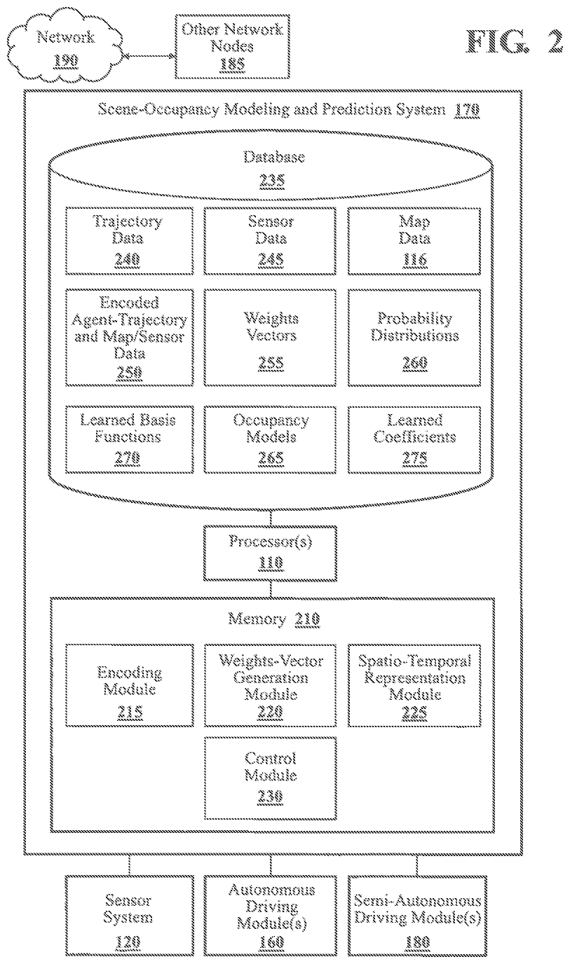

Some of the possible elements of the vehicle 100 are shown in FIG. 1 and will be described in connection with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those skilled in the art, however, will understand that the embodiments described herein may be practiced using various combinations of these elements.

Sensor system 120 can include one or more vehicle sensors 121. Vehicle sensors 121 can include one or more positioning systems such as a dead-reckoning system or a global navigation satellite system (GNSS) such as a global positioning system (GPS). Vehicle sensors 121 can also include Controller-Area-Network (CAN) sensors that output, for example, speed and steering-angle data pertaining to vehicle 100. Sensor system 120 can also include one or more environment sensors 122. Environment sensors 122 generally include, without limitation, radar sensor(s) 123, Light Detection and Ranging (LIDAR) sensor(s) 124, sonar sensor(s) 125, and camera(s) 126. One or more of these various types of environment sensors 122 can be used to detect objects (e.g., external road agents such as other vehicles, bicyclists, motorcyclists, pedestrians, and animals) and, in other respects, understand the environment surrounding vehicle 100 and its associated traffic situations and conditions. This process is sometimes referred to as “traffic-situation understanding” or “scene understanding.”

As discussed above, in embodiments in which vehicle 100 is capable of autonomous operation (e.g., SAE Levels 3-5), vehicle 100 includes autonomous driving module(s) 160 to control various aspects of autonomous driving. As also discussed above, in some embodiments, vehicle 100 is a semi-autonomous vehicle equipped with one or more semi-autonomous driving module(s) 180 such as the types mentioned above.

FIG. 2 is a block diagram of an occupancy system 170, in accordance with an illustrative embodiment of the invention. As mentioned above, certain machine-learning-based components (e.g., neural networks) of occupancy system 170 can be trained at a server, and the trained system can then be downloaded to and deployed in a vehicle 100. FIG. 2 depicts such a system, which operates in vehicle 100 in what is sometimes referred to in the art as “test mode” or “inference mode.” In this embodiment, occupancy system 170 is shown as including one or more processors 110 from the vehicle 100 of FIG. 1. In general, the one or more processors 110 may be a part of occupancy system 170, occupancy system 170 may include one or more separate processors from the one or more processors 110 of the vehicle 100, or occupancy system 170 may access the one or more processors 110 through a data bus or another communication path, depending on the embodiment.

In this embodiment, memory 210 stores an encoding module 215, a weights-vector generation module 220, a spatio-temporal representation module 225, and a control module 230. The memory 210 is a random-access memory (RAM), read-only memory (ROM), a hard-disk drive, a flash memory, or other suitable memory for storing the modules 215, 220, 225, and 230. The modules 215, 220, 225, and 230 are, for example, computer-readable instructions that, when executed by the one or more processors 110, cause the one or more processors 110 to perform the various functions disclosed herein.

As shown in FIG. 2, occupancy system 170 can communicate with one or more other network nodes 185 (e.g., a server where machine-learning-based components of occupancy system 170 are trained, other connected vehicles, cloud servers, edge servers, roadside units, infrastructure) via network 190. Occupancy system 170 can also interface and communicate with sensor system 120 to obtain various kinds of sensor data (e.g., image data, LIDAR data, radar data, etc.) that are input to one or more machine-learning-based models in occupancy system 170. Occupancy system 170 can also interface and communicate with autonomous driving module(s) 160 and/or semi-autonomous driving module(s) 180, depending on the embodiment.

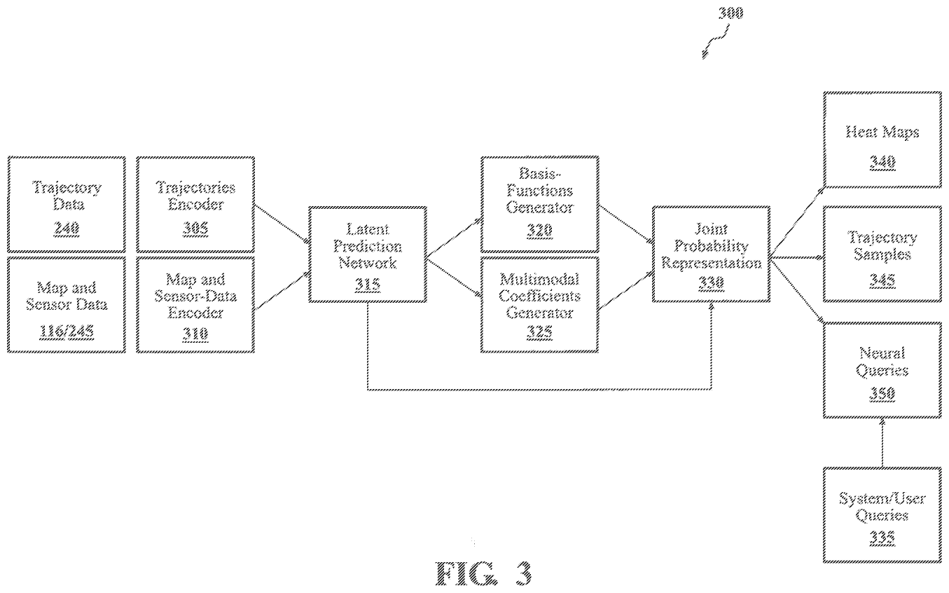

Occupancy system 170 can store various kinds of data in a database 235. One example is trajectory data 240 (e.g., recorded past trajectory data from road agents such as vehicles, motorcycles, bicycles, pedestrians, etc.). Another example is sensor data 245 (image data, LIDAR data, radar data, etc.) from sensor system 120. Database 235 can also store map data 116 (e.g., high-definition (HD) map data or lower-resolution map data), combined encoded input data 250, weights vectors 255 for a GMM, probability distributions 260, occupancy models 265, learned basis functions 270, and learned coefficients 275. These various types of data are discussed in greater detail below in relation to encoding module 215, weights-vector generation module 220, and spatio-temporal representation module 225. These various kinds of data are also discussed below in connection with FIG. 3.

Encoding module 215 generally includes machine-readable instructions that, when executed by the one or more processors 110, cause the one or more processors 110 to process past agent-trajectory data 240, map data 116, and sensor data 245 using one or more encoder neural networks to produce combined encoded input data 250. In some embodiments, encoding module 215 includes a trajectories encoder and a map-and-sensor-data encoder. These neural networks are discussed further below in connection with FIG. 3.

Weights-vector generation module 220 generally includes machine-readable instructions that, when executed by the one or more processors 110, cause the one or more processors 110 to generate a weights vector 255 for a GMM (a model of a multimodal probability distribution) based on the combined encoded input data 250. The generation of weights vectors 255 is discussed further below in connection with FIG. 3.

Spatio-temporal representation module 225 generally includes machine-readable instructions that, when executed by the one or more processors 110, cause the one or more processors 110 to produce a volumetric spatio-temporal representation of occupancy (sometimes referred to herein as an “occupancy model”) 265 in the environment of the robot (vehicle 100, in this embodiment) by generating, for a plurality of modes of the GMM in accordance with the weights vector 255, corresponding sample probability distributions of scene occupancy 260 based on respective means and variances of the plurality of modes, wherein the respective means and variances sample coefficients 275 of a set of learned basis functions 270. The learned basis functions 270 are one feature that distinguishes, from prior-art approaches, the various embodiments of a scene-occupancy modeling and prediction system described herein. These concepts pertaining to spatio-temporal representation module 225 are discussed further below in connection with FIG. 3.

As mentioned above, in some embodiments, spatio-temporal representation module 225 generates a separate volumetric spatio-temporal representation of occupancy (occupancy model) 265 for each of a plurality of different types of agents (e.g., vehicles and pedestrians).

Control module 230 generally includes machine-readable instructions that, when executed by the one or more processors 110, cause the one or more processors 110 to control the operation of the robot (vehicle 100, in this embodiment) based, at least in part, on the volumetric spatio-temporal representation of occupancy (occupancy model) 265 discussed above. In a vehicular embodiment, controlling the operation of the robot (vehicle 100) includes, in general, controlling one or more of steering, acceleration, and braking. Depending on whether vehicle 100 is a manually driven vehicle, a semi-autonomous vehicle, or an autonomous vehicle, control module 230 can control the operation of vehicle 100 in connection with one of more of a collision warning system, an automatic collision-avoidance system, a planning subsystem of an autonomous driving system (e.g., part of autonomous driving module(s) 160), an Adaptive Cruise Control system, a Lane Keep Assist System, an Advanced Driver Assistance System, and a driver monitoring system (a system within the passenger compartment of vehicle 100 that monitors the alertness, distractedness, biometric data, etc., of a driver). The vehicular systems just mentioned are merely examples. Depending on the particular embodiment, control module 230 can control the operation of vehicle 100 in connection with any of a variety of vehicular systems that benefit from information about agent occupancy in the environment of vehicle 100.

In an embodiment in which spatio-temporal representation module 225 generates a separate occupancy model 265 for each of a plurality of different types of agents (e.g., vehicles and pedestrians), control module 230 controls the operation of the robot (e.g., vehicle 100) based, at least in part, on the plurality of different occupancy models 265 (e.g., an occupancy model 265 for vehicles and a separate occupancy model 265 for pedestrians).

FIG. 3 illustrates a processing flow 300 of the occupancy system 170 discussed above in connection with FIG. 2, in accordance with an illustrative embodiment of the invention. In the embodiment of FIG. 3, trajectory data 240 (e.g., past trajectory data associated with road agents such as vehicles, motorcycles, bicycles, and pedestrians) is input to a trajectories encoder 305. Depending on the embodiment, some possible implementations of trajectories encoder 305 include, without limitation, a Long Short-Term Memory (LSTM) neural network, an attention network, and a transformer network.

Map and sensor data 116/245 is input to a map-and-sensor-data encoder 310. As discussed above, the sensor data 245 can include, for example, HD or low-resolution map data 116, camera image data, LIDAR data, radar data, etc. Depending on the embodiment, some possible implementations of map-and-sensor-data encoder 310, with respect to the map data 116, include, without limitation, a Graph Neural Network (GNN) and a rasterized image processing network such as a convolutional neural network (CNN). With respect to the sensor data 245, some possible implementations of map-and-sensor-data encoder 310 include, without limitation, a CNN and a transformer network. In embodiments in which a scene-occupancy modeling and prediction system is deployed in, for example, a controller for a smart city, additional information such as time of day or day of the week can be included among the data encoded by the map-and-sensor-data encoder 310.

Latent prediction network 315 fuses the trajectory data 240 and map and sensor data 116/245 encoded by the trajectories encoder 305 and the map-and-sensor-data encoder 310, respectively, to produce the combined encoded input data 250 mentioned above in connection with FIG. 2. Depending on the particular embodiment, some possible implementations of latent prediction network 315 include, without limitation, a spatio-temporal CNN with pooling layers for the coefficients and an attention network.

Basis-functions generator 320 generates 3D or 4D basis functions, depending on the embodiment. These learned basis functions 270, generated through a machine-learning-based process, are spatio-temporal basis functions that represent probability of occupancy as function of (x, y, t) (3D basis functions) or (x, y, z, t) (4D basis functions), where x, y, and z represent spatial dimensions, and t represents time. The 4D basis functions 270 are used in an application in which a height (z) dimension is needed.

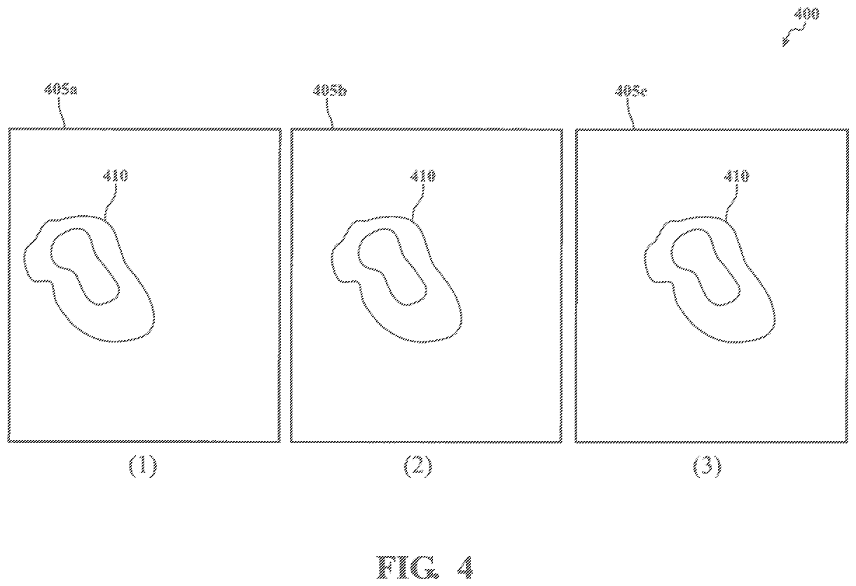

FIG. 4 is a probabilistic agent-movement diagram 400, in accordance with an illustrative embodiment of the invention. FIG. 4 shows a series of three occupancy probability density maps, 405a, 405b, and 405c at corresponding time instants (1), (2), and (3), respectively. Each occupancy probability density map 405 includes level set contours 410.

Referring again to FIG. 3, depending on the embodiment, possible implementations of basis-functions generator 320 include, without limitation, a spatial processing network such as a CNN and a transformer network.

Multimodal coefficients generator 325 generates weights vectors 255 and means and variances for the respective modes of the GMM. From those, multimodal coefficients generator 325 generates learned coefficients 275 for the learned 3D or 4D basis functions 270. Those learned coefficients 275 can either be sampled or summed, depending on whether the objective is to produce a sample trajectory or an overall occupancy estimate. One possible implementation of multimodal coefficients generator 325 is, without limitation, a fully connected neural network, if the latent prediction network 315 has already pooled its output data into a vector.

What the above approach of learning the basis functions 270 and coefficients 275 makes possible is having a specific heat map 340 that captures information such as “Agent A is going in one direction, and Agent B is going in a different direction.” In the various embodiments described herein, occupancy system 170 can capture, in parallel: (1) “Agent A moves first”; (2) “Agent B moves first”; and (3) “Agents A and B move at the same time.” This is merely one multimodal example selected for illustration. In short, the embodiments disclosed herein generate learned basis functions 270 that look like heat maps, and the system learns the coefficients 275 for combining the learned 3D or 4D basis functions 270.

Joint probability representation 330 generates heat maps 340, trajectory samples 345, and neural queries 350. These are discussed further below. The “joint” aspect refers to the learned basis functions 270 and the learned coefficients 275. Joint probability representation 330, which stores the multi-modal probability distributions 260 mentioned above, corresponds to the occupancy models 265 (volumetric spatio-temporal representations of occupancy) discussed above in connection with FIG. 2. In some embodiments, joint probability representation 330 generates a separate occupancy model 265 for each of a plurality of different types of agents (e.g., vehicles, pedestrians, etc., in a vehicular embodiment), as discussed above. Depending on the embodiment, one possible implementation of joint probability representation 330 is, without limitation, a combination of a spatial processing network (e.g., a CNN) and an attention network.

In some embodiments, heat maps 340 are occupancy heat maps in which areas of higher predicted occupancy and lower predicted occupancy are distinguished using various colors (e.g., brighter colors such as white, yellow, or red for high occupancy and darker colors such as green, blue, or black for low occupancy). In other embodiments, information from latent prediction network 315 can be fed to joint probability representation 330 to generate other kinds of heat maps (e.g., a heat map pertaining to whether, given what other agents in the scene are doing, it is safe for a vehicle 100 to traverse a particular trajectory, such as crossing an intersection). Such an embodiment may require additional input map data 116. In still other embodiments, joint probability representation 330 can generate a heat map 340 that shows whether an ego vehicle 100 has the right of way or not in a particular traffic situation. In some embodiments, the components of joint probability representation 330 that generate heat maps 340 include their own spatial processing layer.

Trajectory samples 345 are predicted agent trajectories based on the learned basis functions 270 and the learned coefficients 275. In one embodiment, this can be implemented, without limitation, as a LSTM (or temporal transformer) network with attention heads leading into the spatial map of joint probability representation 330.

Neural queries 350 can answer questions such as, “Can the robot travel along a particular trajectory? What are the chances of a collision with an agent in the environment?” Neural queries 350 can also answer questions like, “Is it polite for a robot to proceed along this particular trajectory?” Thus, neural queries 350, depending on the embodiment, can go beyond simply estimating the probability of a collision; they can extend to predicting whether a robot (e.g., an ego vehicle 100) will encroach on another agent's socially acceptable space. The implementation of the neural queries 350 block can differ somewhat, depending on the embodiment. If the queries concern position, this block (350) pools the specific spatial location from the joint probability representation 330, with or without attention heads, and then processes that data through some fully connected layers, subject, optionally, to coordinates specified by the system or a user. In an embodiment in which the neural queries 350 concern trajectories, an implementation similar to the trajectory samples 345 block can be employed. For example, if a query, “The robot wants to drive through this area. Is that a good or bad idea?” is posed, the system can process the coordinates of the applicable area using an LSTM along with sampled points from the joint probability representation 330 and some output encoding layers to generate a reward model (for the “good or bad idea” aspect).

The system/user queries 335 block poses queries based on position (position queries) or trajectory (trajectory queries).

As mentioned above, during a training phase, the components of a scene-occupancy modeling and prediction system can reside on a server. Once the constituent neural networks have been trained, the system and its trained neural-network components can be downloaded to and deployed in a robot (e.g., a vehicle 100). In general, training the various neural networks in a scene-occupancy modeling and prediction system such as the scene-occupancy modeling and prediction system 170 discussed above involves supervised learning with various types of ground-truth data and the minimization of a cost function (or the maximization of a reward function) expressed, for example, in terms of log-probabilities.

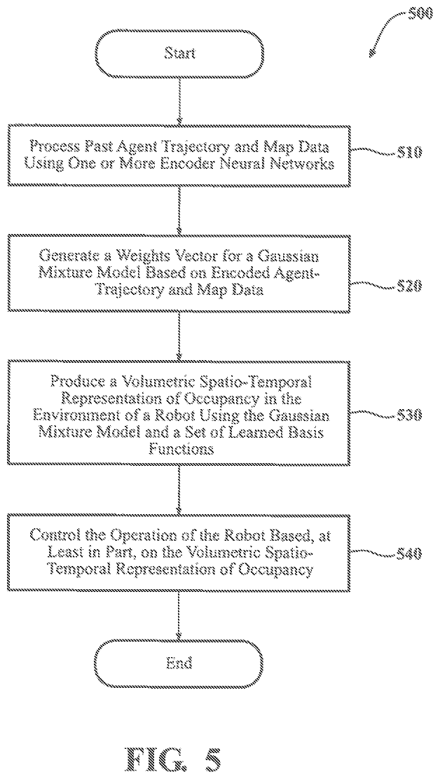

FIG. 5 is a flowchart of a method 500 of modeling and predicting scene occupancy in the environment of a robot. Method 500 will be discussed from the perspective of the scene-occupancy modeling and prediction system 170 discussed above in connection with FIGS. 2 and 3, representing vehicular embodiments. However, the principles underlying method 500 can be applied to scene-occupancy modeling and prediction systems deployed in other kinds of robots, such as a service/assistive robot and a controller for a smart city, as discussed above. Also, while method 500 is discussed in combination with occupancy system 170, it should be appreciated that method 500 is not limited to being implemented within occupancy system 170, but occupancy system 170 is instead one example of a system that may implement method 500.

At block 510, encoding module 215 processes past agent-trajectory data 240, map data 116, and sensor data 245 using one or more encoder neural networks to produce combined encoded input data 250. This is discussed in greater detail above in connection with trajectories encoder 305 and map-and-sensor-data encoder 310 in FIG. 3.

At block 520, weights-vector generation module 220 generates a weights vector 255 for a GMM based on the combined encoded input data 250. This is discussed in greater detail above in connection with multimodal coefficients generator 325 in FIG. 3.

At block 530, spatio-temporal representation module 225 produces a volumetric spatio-temporal representation of occupancy 265 in the environment of the robot (e.g., a vehicle 100) by generating, for a plurality of modes of the GMM in accordance with the weights vector 255, corresponding sample probability distributions 260 of scene occupancy based on respective means and variances of the plurality of modes, wherein the respective means and variances sample coefficients 275 of a set of learned 3D or 4D basis functions 270. This aspect is discussed in greater detail above in connection with the basis-functions generator 320, multimodal coefficients generator 325, and joint probability representation 330 blocks in the processing flow 300 of FIG. 3.

At block 540, control module 230 controls operation of the robot (e.g., vehicle 100) based, at least in part, on the volumetric spatio-temporal representation of occupancy (occupancy model) 265.

As discussed above, in an embodiment in which spatio-temporal representation module 225 generates a separate occupancy model 265 for each of a plurality of different types of agents (e.g., vehicles and pedestrians), control module 230 controls the operation of the robot (vehicle 100) based, at least in part, on the plurality of different occupancy models 265 (e.g., an occupancy model 265 for vehicles and a separate occupancy model 265 for pedestrians).

FIG. 1 will now be discussed in full detail as an example vehicle environment within which the systems and methods disclosed herein may be implemented. In some instances, the vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. In one or more arrangement, the map data 116 can include one or more terrain maps 117. The terrain map(s) 117 can include information about the ground, terrain, roads, surfaces, and/or other features of one or more geographic areas. In one or more arrangement, the map data 116 can include one or more static obstacle maps 118. The static obstacle map(s) 118 can include information about one or more static obstacles located within one or more geographic areas.

The one or more data stores 115 can include sensor data 119. In this context, “sensor data” means any information about the sensors that a vehicle is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120. As discussed above, in some embodiments, vehicle 100 can receive sensor data from other connected vehicles, from devices associated with ORUs, or both.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the vehicle 100. The one or more processors 110 and/or the autonomous driving module(s) 160 may control some or all of these vehicle systems 140 and, thus, may be partially or fully autonomous.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine the position and velocity of the vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-5, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™ Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “module,” as used herein, is not intended, under any circumstances, to invoke interpretation of the appended claims under 35 U.S.C. § 112(f).

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system for modeling and predicting scene occupancy in an environment of a robot, the system comprising:
a processor; and
a memory storing machine-readable instructions that, when executed by the processor, cause the processor to:
process past agent-trajectory data, map data, and sensor data using one or more encoder neural networks to produce combined encoded input data;
generate a weights vector for a Gaussian Mixture Model (GMM) based on the combined encoded input data;
produce a volumetric spatio-temporal representation of occupancy in the environment of the robot by generating, for a plurality of modes of the GMM in accordance with the weights vector, corresponding sample probability distributions of scene occupancy based on respective means and variances of the plurality of modes, wherein the respective means and variances sample coefficients of a set of learned basis functions; and
control operation of the robot based, at least in part, on the volumetric spatio-temporal representation of occupancy.

2. The system of claim 1, wherein the robot is a vehicle.

3. The system of claim 2, wherein the machine-readable instructions to control the operation of the robot include instructions that, when executed by the processor, cause the processor to control one or more of steering, acceleration, and braking.

4. The system of claim 2, wherein the machine-readable instructions to control the operation of the robot are executed in connection with one or more of a collision warning system, an automatic collision-avoidance system, a planning subsystem of an autonomous driving system, an Adaptive Cruise Control system, a Lane Keep Assist System, an Advanced Driver Assistance System, and a driver monitoring system.

5. The system of claim 1, wherein the robot is a service robot.

6. The system of claim 1, wherein the robot is a controller for a smart city.

7. The system of claim 1, wherein:
the volumetric spatio-temporal representation of occupancy models scene occupancy for a particular category of agent;
the machine-readable instructions to produce the volumetric spatio-temporal representation of occupancy include instructions that, when executed by the processor, cause the processor to produce an additional volumetric spatio-temporal representation of occupancy that models scene occupancy for a category of agent different from the particular category; and
the machine-readable instructions to control the operation of the robot include instructions that, when executed by the processor, cause the processor to control the operation of the robot based, at least in part, on the volumetric spatio-temporal representation of occupancy and the additional volumetric spatio-temporal representation of occupancy.

8. The system of claim 7, wherein the robot is a vehicle, the particular category of agent is vehicles, and the category of agent different from the particular category is pedestrians.

9. The system of claim 1, wherein the learned basis functions in the set of learned basis functions are polynomial basis functions.

10. The system of claim 1, wherein the learned basis functions are one of three-dimensional (x, y, t) and four-dimensional (x, y, z, t).

11. A non-transitory computer-readable medium for modeling and predicting scene occupancy in an environment of a robot and storing instructions that, when executed by a processor, cause the processor to:
process past agent-trajectory data, map data, and sensor data using one or more encoder neural networks to produce combined encoded input data;
generate a weights vector for a Gaussian Mixture Model (GMM) based on the combined encoded input data;
produce a volumetric spatio-temporal representation of occupancy in the environment of the robot by generating, for a plurality of modes of the GMM in accordance with the weights vector, corresponding sample probability distributions of scene occupancy based on respective means and variances of the plurality of modes, wherein the respective means and variances sample coefficients of a set of learned basis functions; and
control operation of the robot based, at least in part, on the volumetric spatio-temporal representation of occupancy.

12. The non-transitory computer-readable medium of claim 11, wherein the robot is a vehicle.

13. A method, comprising:
processing past agent-trajectory data, map data, and sensor data using one or more encoder neural networks to produce combined encoded input data;
generating a weights vector for a Gaussian Mixture Model (GMM) based on the combined encoded input data;
producing a volumetric spatio-temporal representation of occupancy in an environment of a robot by generating, for a plurality of modes of the GMM in accordance with the weights vector, corresponding sample probability distributions of scene occupancy based on respective means and variances of the plurality of modes, wherein the respective means and variances sample coefficients of a set of learned basis functions; and
controlling operation of the robot based, at least in part, on the volumetric spatio-temporal representation of occupancy.

14. The method of claim 13, wherein the robot is a vehicle.

15. The method of claim 14, wherein controlling the operation of the robot includes controlling one or more of steering, acceleration, and braking.

16. The method of claim 14, wherein controlling the operation of the robot is associated with one or more of a collision warning system, an automatic collision-avoidance system, a planning subsystem of an autonomous driving system, an Adaptive Cruise Control system, a Lane Keep Assist System, an Advanced Driver Assistance System, and a driver monitoring system.

17. The method of claim 13, wherein the robot is a service robot.

18. The method of claim 13, wherein the robot is a controller for a smart city.

19. The method of claim 13, wherein:
the volumetric spatio-temporal representation of occupancy models scene occupancy for a particular category of agent;
the method further comprises producing an additional volumetric spatio-temporal representation of occupancy that models scene occupancy for a category of agent different from the particular category; and
controlling the operation of the robot is based, at least in part, on the volumetric spatio-temporal representation of occupancy and the additional volumetric spatio-temporal representation of occupancy.

20. The method of claim 19, wherein the robot is a vehicle, the particular category of agent is vehicles, and the category of agent different from the particular category is pedestrians.
